(19) United States
(12) Patent Application Publication
(10) Pub. No.: US 2007/0200990 A1
(43) Pub. Date: Aug. 30, 2007

(54) LIQUID CRYSTAL DISPLAY DEVICE

(75) Inventors: Jin Hirosawa, Saitama-shi (JP); Norihiro Yoshida, Kumagaya-shi (JP); Arihiro Takeda, Sagamihara-shi (JP); Reiko Suwa, Kawaguchi-shi (JP); Hiroyuki Kimura, Fukaya-shi (JP); Hiroshi Tabatake, Fukaya-shi (JP); Yuuki Morita, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/673,168

(22) Filed: Feb. 9, 2007

(30) Foreign Application Priority Data
Feb. 24, 2006 (JP) 2006-048606

(51) Int. Cl. G02F 1/1337; C09K 19/02

(52) U.S. Cl. 349/129; 349/178

(57) ABSTRACT

In order to suppress noise in display, which would occur due to variations of inclination directions of liquid crystal molecules, and to improve display quality, a first structure in a shape having a discontinuous portion is provided to a first electrode, and a second structure is provided to a second electrode so as to face the discontinuous portion of the first structure. When a voltage is applied to the first and second electrodes to generate an electric field in a liquid crystal layer, the first structure controls the inclination directions of the liquid crystal molecules, and the second structure controls the inclination directions of the liquid crystal molecules existing in the discontinuous portion of the first structure. In the discontinuous portion of the first structure, the amount of light passing through the liquid crystal layer increases, and the liquid crystal molecules are aligned more vertically. Hence, light leakage is reduced.

### CROSS-REFERENCE TO RELATED APPLICATIONS

This application is based upon and claims the benefit of priority from Japanese Patent Application No. 2006-48606 filed Feb. 24, 2006; the entire contents of which are incorporated herein by reference.

### BACKGROUND OF THE INVENTION

1. Field of the Invention

The present invention relates to a liquid crystal display device in which a liquid crystal having a negative dielectric anisotropy is used.

2. Description of the Related Art

In recent years, there has been proposed a Vertical Alignment mode liquid crystal display device in which a liquid crystal having a negative dielectric anisotropy is used. In this liquid crystal display device, liquid crystal molecules are aligned vertically to a substrate by using an alignment layer so that a birefringence of a liquid crystal layer is substantially zero. Thereby, sufficient black display can be achieved and high contrast can be concurrently obtained.

Moreover, a liquid crystal display device of a Multi-domain Vertical Alignment mode (MVA mode) has been proposed. In this liquid crystal display device, a structure is disposed in an area on a substrate, and divides the area into a plurality of domains having inclination directions of liquid crystal molecules different from one another. This configuration achieves a favorable display quality, such as contrast, and also a wide viewing angle characteristic.

Recently, there has been developed a MVA mode liquid crystal display device as disclosed in Japanese Patent Application Laid-open No. 2005-202034. This liquid crystal display device includes projections on a substrate. Each of the projections controls inclination directions of liquid crystal molecules so that the influence of an electric field vector around an electrode wiring can be suppressed to the minimum. Accordingly, a display defect, such as residue and stain-like unevenness, can be suppressed.

However, in the conventional liquid crystal display devices, there is a case where projections on a substrate affect the quality of display. For example, in a case where the number of projections is reduced, inclination directions of liquid crystal molecules vary in a region where no projection exists. As a result, there is a problem that noise is caused in a display. On the other hand, in a case where the number of projections is increased, the amount of light passing through a liquid crystal layer decreases, and transmittivity declines. In addition, there is a problem that deterioration in verticalness of liquid crystal molecules causes contrast deterioration and light leakage.

### SUMMARY OF THE INVENTION

An object of the present invention is, in a MVA mode liquid crystal display, to suppress noise in display caused by variations of inclination directions of liquid crystal molecules, and to improve quality of display such as transmittivity and contrast.

A first aspect of the present invention provides a liquid crystal display device which includes first and second substrates which are disposed so as to face each other with a gap interposed in between, a first electrode disposed on the first substrate, a second electrode which is disposed on the second substrate, and which faces the first electrode, a liquid crystal layer which is held in the gap between the substrates, and which is formed of liquid crystal molecules having a negative dielectric anisotropy, a first structure provided to the first electrode in a shape including a discontinuous portion therein, and which controls inclination directions of the liquid crystal molecules, and a second structure which is provided to the second electrode, and which faces the discontinuous portion of the first structure provided in a shape including a discontinuous portion therein.

In the present invention, the first structure is provided to the first electrode in a shape including a discontinuous portion therein, and the second structure is provided to the second electrode so as to face the discontinuous portion of the first structure. In a case where a voltage is applied to the first and second electrodes to generate an electric field in the liquid crystal layer, the first structure controls the inclination directions of the liquid crystal molecules, and the second structure controls the inclination directions of the liquid crystal molecules present in the discontinuous portion of the first structure. Furthermore, in a region where the first structure is divided, an amount of light passing through the liquid crystal layer increases, and the liquid crystal molecules are aligned more vertically so that light leakage is reduced.

A second aspect of the present invention provides the above-described liquid crystal display device characterized in that the first structure is a projection provided to the first electrode in a shape including a discontinuous portion therein, and that the second structure is a slit which faces the discontinuous portion of the projection, and which is formed by partially removing the second electrode.

A third aspect of the present invention provides the above-described liquid crystal display device characterized in that the first structure is a slit which is formed by partially removing the first electrode in a shape including a discontinuous portion therein, and that the second structure is a slit which faces the discontinuous portion of the slit, and which is formed by partially removing the second electrode.

A fourth aspect of the present invention provides the above-described liquid crystal display device characterized in that the first structure is a projection provided to the first electrode in a shape including a discontinuous portion therein, and the second structure is a projection provided to the second electrode so as to face the discontinuous portion of the projection.

A fifth aspect of the present invention provides the above-described liquid crystal display device characterized in that all the portions of the projection on the first electrode extends in one direction, and that each slit on the second electrode extends in a direction perpendicular to the direction in which all the portions of the projection extends.

A sixth aspect of the present invention provides the above-described liquid crystal display device characterized in that all the portions of the slit on the first electrode extends in one direction, and that the slit on the second electrode extends in a direction perpendicular to the direction in which all the portions of the slit on the first electrode extends.

A seventh aspect of the present invention provides the above-described liquid crystal display device further including a stepped portion which is provided to at least one of the first and second substrates, and which adjusts a thickness of the liquid crystal layer. The second electrode is formed of a reflective electrode and a transmissive electrode, the reflective electrode being disposed in a first region where the stepped makes the liquid crystal layer thinner than a second reason, and the transmissive electrode being disposed in the second region where the liquid crystal layer is thicker. In addition, the second structure straddles a boundary between the above regions.

An eighth aspect of the present invention provides the above-described liquid crystal display device further including a stepped portion which is provided to at least one of the first and second substrates, and which adjusts a thickness of the liquid crystal layer. The second electrode is formed of a reflective electrode and a transmissive electrode, the reflective electrode being disposed in a first region where the stepped makes the liquid crystal layer thinner than a second reason, and the transmissive electrode being disposed in the second region where the liquid crystal layer is thicker. In addition, the second structure is placed along a boundary between the above regions.

### BRIEF DESCRIPTION OF THE DRAWINGS

FIG. 1 is a perspective view of a liquid crystal display device of a first embodiment;

FIG. 2 is a circuit diagram on an array substrate in the liquid crystal display device of FIG. 1;

FIG. 3 is a cross-sectional view of the array substrate in the liquid crystal display device of FIG. 1;

FIG. 4 is a cross-sectional view of the liquid crystal display device of FIG. 1;

FIG. 5 is a plan view of one pixel disposed on the liquid crystal display device of FIG. 1;

FIG. 6 is a cross-sectional view taken along the line A-A of FIG. 5;

FIG. 7 is a cross-sectional view taken along the line B-B of FIG. 5;

FIG. 8 is a cross-sectional view taken along the line C-C of FIG. 5;

FIG. 9 is a cross-sectional view taken along the line A-A of FIG. 5 at the time of displaying an image;

FIG. 10 is a cross-sectional view taken along the line B-B of FIG. 5 at the time of displaying an image;

FIG. 11 is a cross-sectional view taken along the line C-C of FIG. 5 at the time of displaying an image;

FIG. 12 is a plan view of one pixel at the time of displaying an image;

FIG. 13 is a plan view of one pixel disposed on a liquid crystal display device of a second embodiment;

FIG. 14 is a cross-sectional view taken along the line A-A of FIG. 13 at the time of displaying an image;

FIG. 15 is a cross-sectional view taken along the line B-B of FIG. 13 at the time of displaying an image;

FIG. 16 is a cross-sectional view taken along the line C-C of FIG. 13 at the time of displaying an image;

FIG. 17A is a plan view of one pixel disposed on a liquid crystal display device of a first comparative example;

FIG. 17B is a cross-sectional view taken along the line I-I of FIG. 17A;

FIG. 18A is a plan view of one pixel disposed on a liquid crystal display device of a second comparative example;

FIG. 18B is a cross-sectional view taken along the line I-I of FIG. 17A;

FIG. 19 shows results of comparing noise in display of the embodiments with that of the comparative examples;

FIG. 20 shows results of comparing a display quality of the embodiments with that of the comparative examples;

FIG. 21 is a plan view of one pixel disposed on a liquid crystal display device of a third embodiment;

FIG. 22 is a cross-sectional view taken along the line I-I of FIG. 21;

FIG. 23 is a cross-sectional view taken along the line I-I of FIG. 21 at the time of displaying an image;

FIG. 24 is a plan view of one pixel disposed on a liquid crystal display device of a third comparative example;

FIG. 25 is a cross-sectional view taken along the line I-I of FIG. 24;

FIG. 26 is a cross-sectional view taken along the line I-I of FIG. 24 at the time of displaying an image;

FIG. 27 is a cross-sectional view of an array substrate in a liquid crystal display device of a fourth embodiment;

FIG. 28 is a plan view of one pixel disposed on the liquid crystal display device;

FIG. 29 is a plan view of one pixel disposed on a liquid crystal display device of a first modified example; and

FIG. 30 is a plan view of one pixel disposed on a liquid crystal display device of a second modified example.

### DESCRIPTION OF THE EMBODIMENT

### First Embodiment

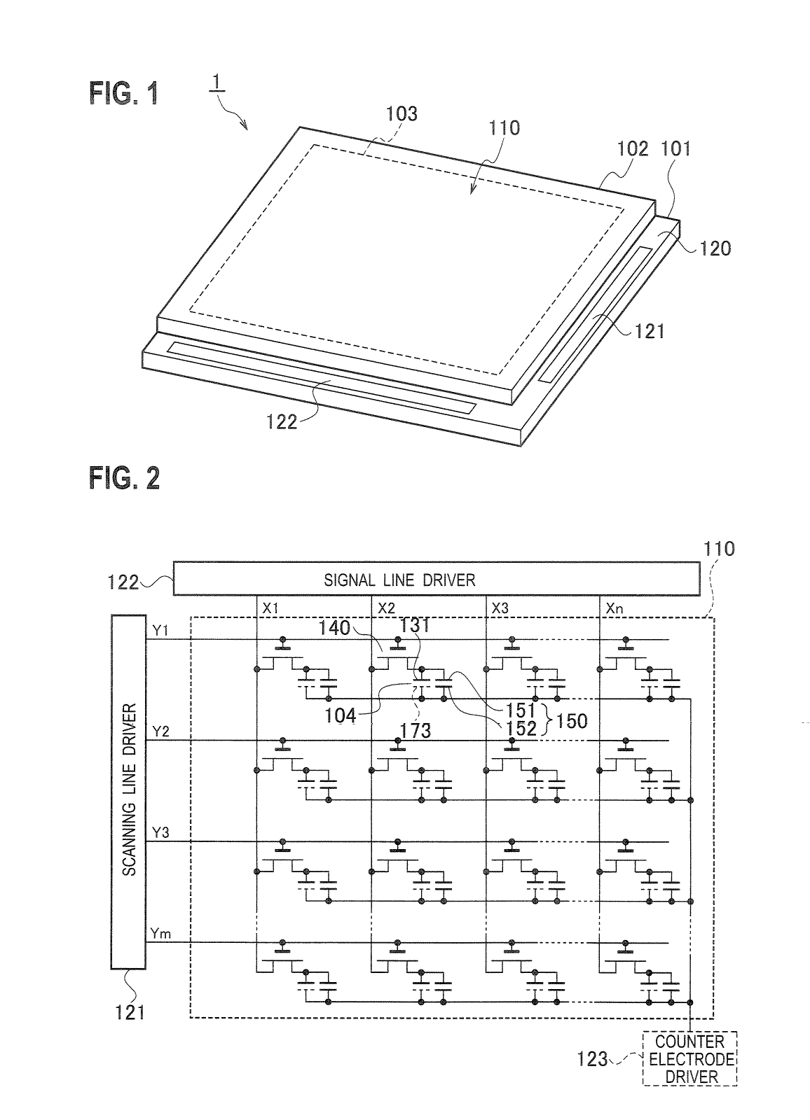

As shown in a perspective view of FIG. 1, a liquid crystal display device 1 of the present embodiment is provided with an array substrate 101 as a second substrate, an opposite substrate 102 as a first substrate disposed as facing the array substrate 101, and a liquid crystal layer 104 held in a gap between the substrates. The liquid crystal layer 104 is formed of liquid crystal molecules having a negative dielectric anisotropy. The liquid crystal molecules are aligned vertically to the two substrates. The array substrate 101 and the opposite substrate 102 are bonded together by a sealing member 103. A display region 110 is provided to a region defined by the sealing member 103. Furthermore, a circumferential region 120 is provided along an outer circumference of the display region 110. The liquid crystal display device 1 is a transmissive liquid crystal display device, and displays images by using light of an unillustrated backlight disposed in the back side of the array substrate 101.

As shown in a circuit diagram of FIG. 2, on the array substrate 101, the liquid crystal display device 1 includes the display region 110 and the circumferential region 120 in which a scanning line driving circuit 121, a signal line driving circuit 122 an opposite electrode driving circuit 123 are disposed.

In the display region 110, m scanning lines Y1 to Ym and n signal lines X1 to Xn are wired in a way that each of the scanning lines and each of the signal lines intersect each other. At each intersection, a thin film transistor 140 (pixel TFT: Thin Film Transistor) as a switching element, a pixel electrode 131 as a second electrode, and an auxiliary capacity 150 are disposed. The auxiliary capacity 150 is formed of an auxiliary capacity electrode 151 and an auxiliary capacity line 152.

Specifically, a drain terminal of the pixel TFT 140 is connected to a signal line X, a source terminal is connected in parallel to the auxiliary capacity electrode 151 and to the pixel electrode 131, and a gate terminal is connected to a scanning line Y. An opposite electrode 173 as the first electrode is disposed on the opposite substrate 102 as facing all of the pixel electrodes 131 across the liquid crystal layer 104. Here, the auxiliary capacity electrode 151 is set to have a potential equal to that of the pixel electrode 131.

The scanning line driving circuit 121 drives the m scanning lines Y1 to Ym wired in parallel. The signal line driving circuit 122 drives the n signal lines X1 to Xn wired in parallel. The opposite electrode driving circuit 123 is connected to each of the auxiliary capacity line 152 and each of the opposite electrode 173 to supply a predetermined voltage thereto.

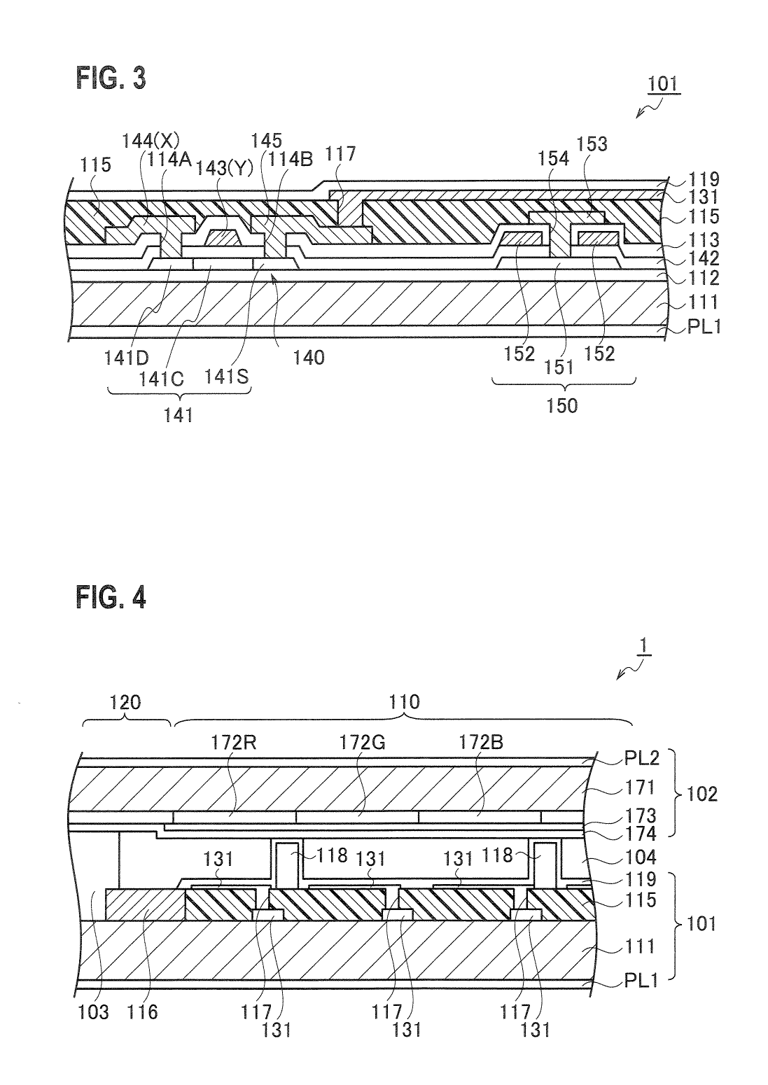

FIG. 3 is a cross-sectional view of the array substrate 101, and shows an intersection of the scanning line Y and the signal line X. An undercoat layer 112 is formed on a transparent insulative substrate 111 such as a glass substrate. A polarizing plate PL1 is provided to the back side of the insulative substrate 111. On the undercoat layer 112, a semiconductor layer 141 constituting the pixel TFT 140 is formed of a polysilicon film. The semiconductor layer 141 is provided with a channel region 141C, a drain region 141D each side of which is doped with an impurity, and a source region 141S.

Furthermore, a gate insulative film 142 is formed on the semiconductor layer 141 and on the auxiliary capacity electrode 151. On this gate insulative film 142, the scanning line Y incorporated with a gate electrode 143, and an auxiliary capacity line 152 are formed. The auxiliary capacity line 152 is formed of the same material with that of the scanning line Y, and is formed substantially parallel to the scanning line Y. One portion of the auxiliary capacity line 152 is formed as facing the auxiliary capacity electrode 151. The auxiliary capacity 150 is formed of the auxiliary capacity line 152 and the auxiliary capacity electrode 151.

An interlayer insulative film 113 is formed on the gate insulative film 142, the gate electrode 143, the scanning line Y, and the auxiliary capacity line 152. On this interlayer insulative film 113, the signal line X incorporated with the drain electrode 144, the source electrode 145, and a contact electrode 153 are formed. The signal line X is formed in a way that the signal line X is substantially orthogonal to the scanning line Y and the auxiliary capacity line 152. Here, a low-resistance material having a light shielding effect is suitable for materials of the signal lines X, the scanning line Y, and the auxiliary capacity line 152. In this event, as one example, Molybdenum-Tungsten is used for the scanning line Y and the auxiliary capacity line 152, and Aluminum is used for the signal line X.

Contact holes 114A and 114B pass through the gate insulative film 142 and the interlayer insulative film 113. The drain electrode 144 is connected to a drain region 141D of the semiconductor layer 141 through the contact hole 114A. The source electrode 145 is connected to a source region 141S of the semiconductor layer 141 through the contact hole 114B. A contact hole 154 passes through the gate insulative film 142 and the interlayer insulative film 113. The contact electrode 153 is connected to the auxiliary capacity electrode 151 through the contact hole 154. Since the contact electrode 153 is connected to the signal line X formed of the same material as the contact electrode 153, the source electrode 145, the pixel electrode 131, and the auxiliary capacity electrode 151 always mutually have the same potential.

A transparent resin layer 115 is formed on the interlayer insulative film 113, the drain electrode 144, the source electrode 145, the scanning line Y, the signal line X, and the contact electrode 153. On this transparent resin layer 115, the pixel electrode 131 is formed. A light-transmissive conductive member, such as indium tin oxide (ITO), is used for the pixel electrode 131. The pixel electrode 131 functions as a transmissive electrode in the transmissive liquid crystal display device 1. In this manner, the pixel electrode 131 as the second electrode is disposed on the array substrate 101. The pixel electrode 131 is connected to the source electrode 145 through a contact hole 117 passing through the transparent resin layer 115. An alignment layer 119 is formed on the transparent resin layer 115 and the pixel electrode 131.

FIG. 4 is a cross-sectional view of the liquid crystal display device 1, and shows a vicinity of the boundary between the display region 110 and the circumferential region 120. In the display region 110, a columnar spacer 118 is formed on the insulative substrate 111 and the transparent resin layer 115. Here, a height of the columnar spacer is set at 2.0 μm, for example. Moreover, the alignment layer 119 is formed on the transparent resin layer 115 and the pixel electrode 131 in a manner that the alignment layer 119 covers the columnar spacer 118 as well as the transparent resin layer 115 and the pixel electrode 131. The alignment layer 119 aligns the liquid crystal molecules constituting the liquid crystal layer 104 to be substantially vertical to the array substrate 101. Here, in the circumferential region 120, a light shielding film 116 is formed on the insulative substrate 111 in order to prevent light leakage.

On the other hand, the opposite substrate 102 is bonded to the array substrate 101 by the sealing member 103. A polarizing plate PL 2 is provided to the back side of the transparent insulative substrate 171 such as a glass substrate. In the display region 110, a red color filter layer 172R, a green color filter layer 172G and a blue color filter layer 172B are formed on the insulative substrate 171. The opposite electrode 173 is further formed on the insulative substrate 171 in a way that the opposite electrode 173 faces all of the pixel electrodes 131. Accordingly, the opposite electrode 173 as the first electrode is disposed as facing the pixel electrode 131 as the second electrode.

Here, ITO is used for the opposite electrode 173, as a high light transmissive conductive material. An alignment layer 174 is formed on the opposite electrode 173. The alignment layer 174 aligns the liquid crystal molecules constituting the liquid crystal layer 104 to be substantially vertical to the opposite substrate 102.

With this structure, when an image is displayed in the liquid crystal display device 1, the scanning lines Y1 to Ym are sequentially driven by the scanning line driving circuit 121 to turn on each of the pixel TFT 140. In addition, the signal line driving circuit 122 drives the signal lines X1 to Xn, so that image signals are supplied to the pixel electrode 131 of each pixel TFT 140 and to the auxiliary capacity electrode 151. At this time, a predetermined potential is supplied from the opposite electrode driving circuit 123 to the opposite electrode 173 and to each auxiliary capacity line 152. The pixel electrode 131 and the auxiliary capacity 150 hold a voltage equivalent to the image signals. In this manner, the image signals are written to the pixel TFT 140.

A voltage corresponding to a value of the image signals is applied between the pixel electrode 131 of each pixel TFT 140 and the opposite electrode 173. Thereby, an electric field is generated in the liquid crystal layer 104. The generated electric field aligns the liquid crystal molecules having a negative dielectric anisotropy. In a state where a voltage is not applied between the electrodes, or where a voltage less than a threshold is applied, the liquid crystal molecules are aligned to be substantially vertical to the substrate. On the other hand, in a state where a voltage equal to a threshold or more is applied, the liquid crystal molecules are aligned in a way that the molecules incline, or are substantially parallel to the substrate. In this event, the inclination directions of the liquid crystal molecules are roughly defined by the generated electric field. Then, light irradiated from the backlight positioned in the back side of the array substrate 101 transmits the liquid crystal layer 104 and the color filter 172. As a result, a color image is displayed in the display region 110.

The liquid crystal display device 1 of the present embodiment is provided with the first structure which is provided to the opposite electrode 173 in a shape including a discontinuous portion therein, and which controls the inclination directions of the liquid crystal molecules and the second structure provided to the pixel electrode 131 so as to face the discontinuous portion of the first structure provided in a shape including a discontinuous portion therein.

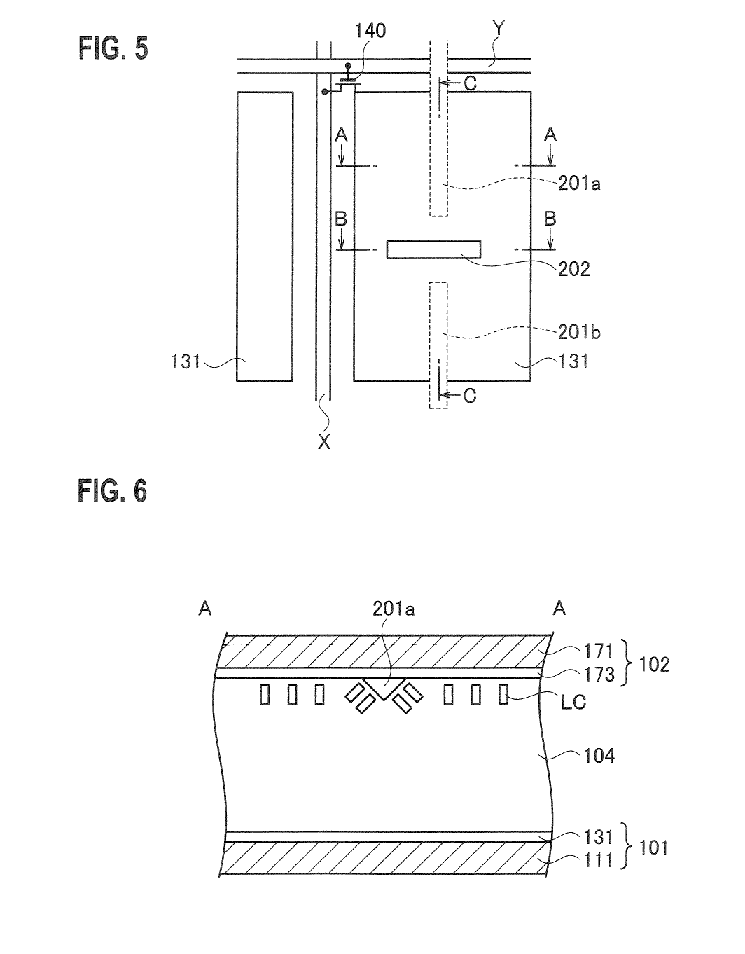

Descriptions will be given in detail below by referring to the drawings. A plan view of FIG. 5 shows one pixel disposed on the liquid crystal display device 1. The pixel TFT 140 and the pixel electrode 131 are disposed on the array substrate at the intersection of the scanning line Y and the signal line X wired in a way that the scanning line Y and the signal line X intersect each other. The projections 201a and 201b, which are shown by the dotted lines, are provided to the opposite electrode 173 as the first structures in shapes each including a discontinuous portion therein. The projections 201a and 201b project to the array substrate side with a size of 1 μm in height and 6 um in width, and are divided around the center of the pixel electrode 131.

Each of the projections 201a and 201b extends in one direction. In this event, each of the projections extends in a direction parallel to the signal line X. The projections 201a and 201b are provided to each pixel. Here, a dielectric material is used for the projections 201a and 201b, and a value of permittivity is set to a value at which an electric field generated in the liquid crystal avoids these projections. In this manner, the dielectric projections 201a and 201b are provided in a shape including a discontinuous portion therein. An amount of light passing through the liquid crystal layer 104 increases in the discontinuous region. Accordingly, the transmittivity of light is improved.

On the other hand, a slit 202 is provided as a second structure by partially removing the pixel electrode 131. The slit 202 faces the discontinuous portion of the projections 201a and 201b. The slit 202 extends in a direction perpendicular to the direction in which the projections 201a and 201b extend. Here, the length in the scanning line Y direction is set at 10 μm, and the width in the signal line X direction is set at 4 μm.

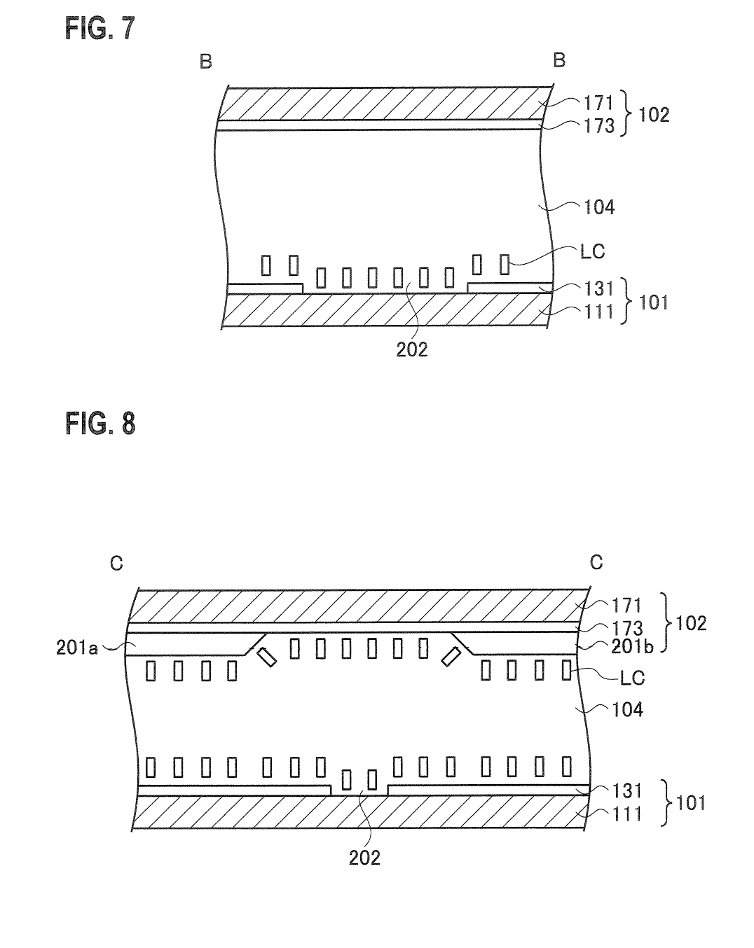

FIGS. 6 to 8 show cross-sectional views of one pixel in a case where a voltage is not applied to the pixel electrode 131 and the opposite electrode 173. FIG. 6 is a cross-sectional view taken along the line A-A of FIG. 5, FIG. 7 is a cross-sectional view taken along the line B-B of FIG. 5, and FIG. 8 is a cross-sectional view taken along the line C-C of FIG. 5. FIGS. 6 to 8 schematically show the array substrate 101 as the second substrate, the pixel electrode 131 as the second electrode, the opposite substrate 102 as the first substrate, and the opposite electrode 173 as the first electrode. The liquid crystal molecules LC present in the vicinity of each of surfaces of the pixel electrode 131 and of the opposite electrode 173 are shown by rectangles.

As shown in the cross-sectional views of FIGS. 7 and 8, the liquid crystal molecules LC at the side of the array substrate 101 are aligned vertically to surfaces of the pixel electrode 131 and of the slit 202. On the other hand, as shown in the cross-sectional views of FIGS. 6 and 8, the liquid crystal molecules LC at the side of the opposite substrate 102 are aligned vertically to surfaces of the opposite electrode 173 and of the projections 201a and 201b. Alignments of the liquid crystal molecules present in the vicinity of the surfaces of the projections are not easily made vertical to the opposite substrate. Here, the projections 201a and 201b are provided in a shape including a discontinuous portion therein. Thereby, the liquid crystal molecules in the discontinuous portion where the projections 201a and 201b are absent can be aligned more vertically. In this manner, light leakage is reduced in a state where a voltage is not applied. Thus, a favorable black display can be achieved, and thus contrast improves.

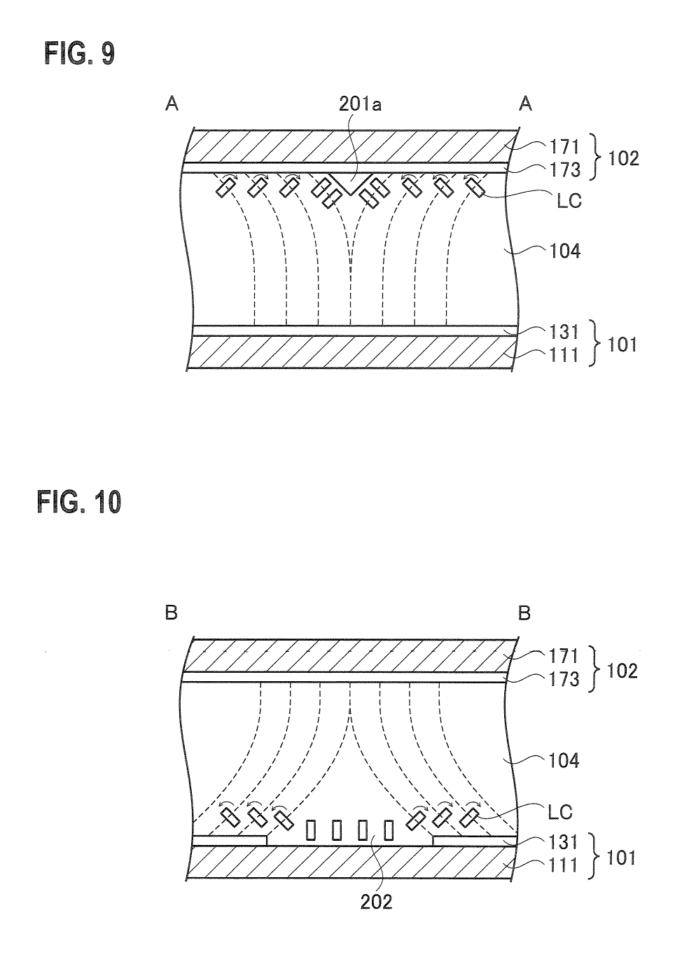

Next, descriptions will be provided in detail for states of the liquid crystal molecules in a case where an image is displayed on the liquid crystal display device 1. FIGS. 9 to 11 show cross-sectional views of one pixel in a case where a voltage is applied to the pixel electrode 131 and the opposite electrode 173. A potential difference is caused in accordance with a value of the image signals applied between the pixel electrode 131 and the opposite electrode 173. The liquid crystal molecules are aligned by the electric field generated in the liquid crystal layer 104. In FIGS. 9 to 11, an electric flux lines indicating a distribution of the generated electric field is shown by the dotted line.

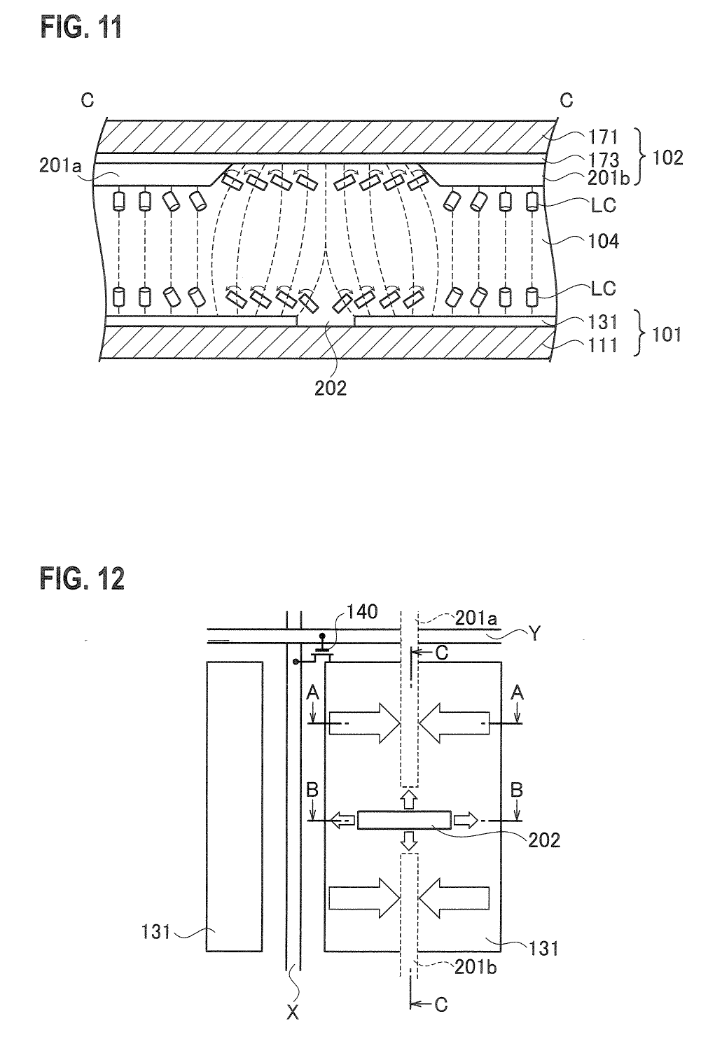

As shown in the cross-sectional views of FIGS. 9 and 11, the electric field generated in a vicinity of the opposite electrode 173 is distributed in a manner that the electric field is kept off the projections 201a and 201b. Thereby, at the side of the opposite substrate 102, the liquid crystal molecules LC aligned vertically to the surfaces of the opposite electrode 173 and of the projections 201a and 201b incline toward the inside of the projections 201a and 201b.

On the other hand, as shown in the cross-sectional views of FIGS. 10 and 11, the electric field generated in a vicinity of the pixel electrode 131 is distributed in a manner that the electric field is kept off the slit 202. Thereby, at the side of the array substrate 101, the liquid crystal molecules LC aligned vertically to the surfaces of the pixel electrode 131 and of the slit 202 incline toward the outside of the slit 202.

A plan view of FIG. 12 shows the plan view of one pixel in a case of displaying an image. Arrows in FIG. 12 show inclination directions of the liquid crystal molecules. The projections 201a and 201b control the inclination directions of the liquid crystal molecules to be in a direction toward the inside of the projections 201a and 201b. On the other hand, the slit 202 controls the inclination directions of the liquid crystal molecules present in the discontinuous portion of the projections 201a and 201b to be in a direction toward the outside of the slit 202. With this, variations of the inclination directions of the liquid crystal molecules in each pixel can be suppressed. Thus, noise in display in the liquid crystal display device 1 can be suppressed.

As described above, according to the first embodiment, the projections 201a and 201b are provided to the opposite electrode 173 in a shape including a discontinuous portion, and the slit 202 of the pixel electrode 131 is provided so as to face the discontinuous portion of the projections. In a case where a voltage is applied to the pixel electrode 131 and to the opposite electrode 173 to generate an electric field in the liquid crystal layer 104, the projections 201a and 201b control the inclination directions of the liquid crystal molecules LC, and the slit 202 controls the inclination directions of the liquid crystal molecules LC present in the discontinuous portions of the projections. In the region where the projections are divided, the amount of light passing through the liquid crystal layer 104 increases, and the liquid crystal molecules are aligned more vertically. Hence, light leakage is reduced, and a favorable black display can be achieved.

As a result, noise in display due to variations of the inclination directions of the liquid crystal molecules can be suppressed, and a quality of display, such as transmittivity and contrast, can be improved.

In addition, it is desirable that each of the projections 201a and 201b extend in one direction, and that the slit 202 extend in a direction perpendicular to the direction in which the projections 201a and 201b extend.

### Second Embodiment

A basic configuration of a liquid crystal display device of a second embodiment is similar to that described in the first embodiment. Descriptions will be subsequently provided below for points different from the first embodiment.

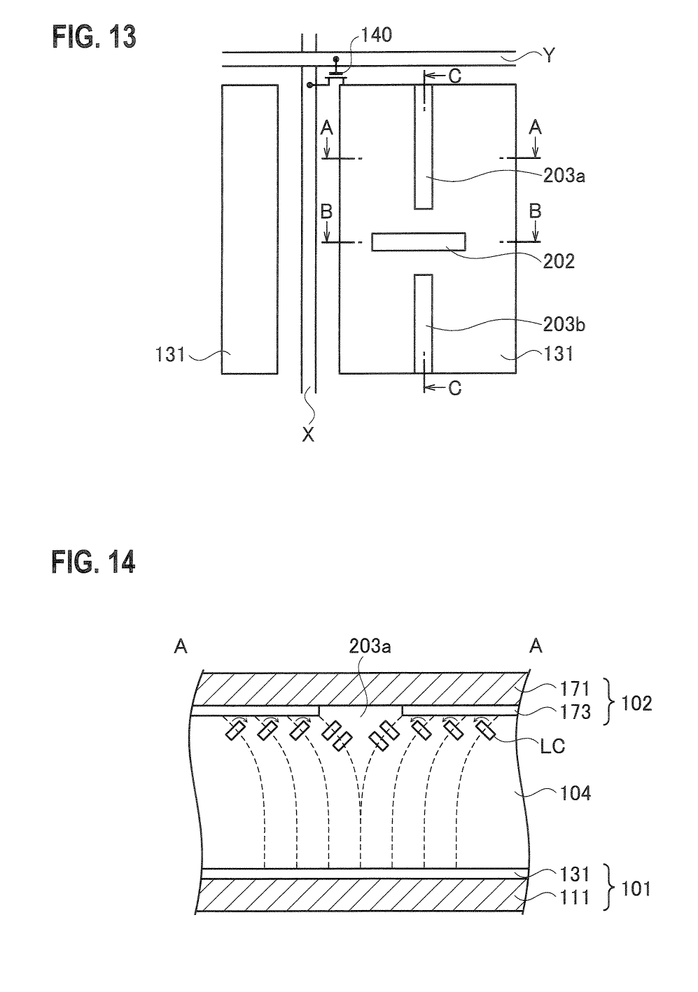

As shown in a plan view of FIG. 13, the second embodiment is different from the first embodiment in the following points. Specifically, a first structure is slits 203a and 203b which is formed by partially removing the opposite electrode 173 in a shape including a discontinuous portion therein, instead of being projections 201a and 201b provided to an opposite electrode 173. A second structure is a slit 202 which faces a discontinuous portion of the slits 203a and 203b, and from which a pixel electrode 131 is partially removed.

All the portions of the slits 203a and 203b on the opposite electrode 173 extend in one direction. Here, the slits 203a and 203b extend in a direction parallel to a signal line X. The slits 203a and 203b are provided to each pixel. The width of the slits 203a and 203b is set at 4 μm. The slit 202 of the pixel electrode 131 extends in a direction perpendicular to the direction in which the slits 203a and 203b extend. Here, as in the case of the first embodiment, the length of a direction of a scanning line Y is set at 10 μm, and the width of a direction of a signal line X is set at 4 μm.

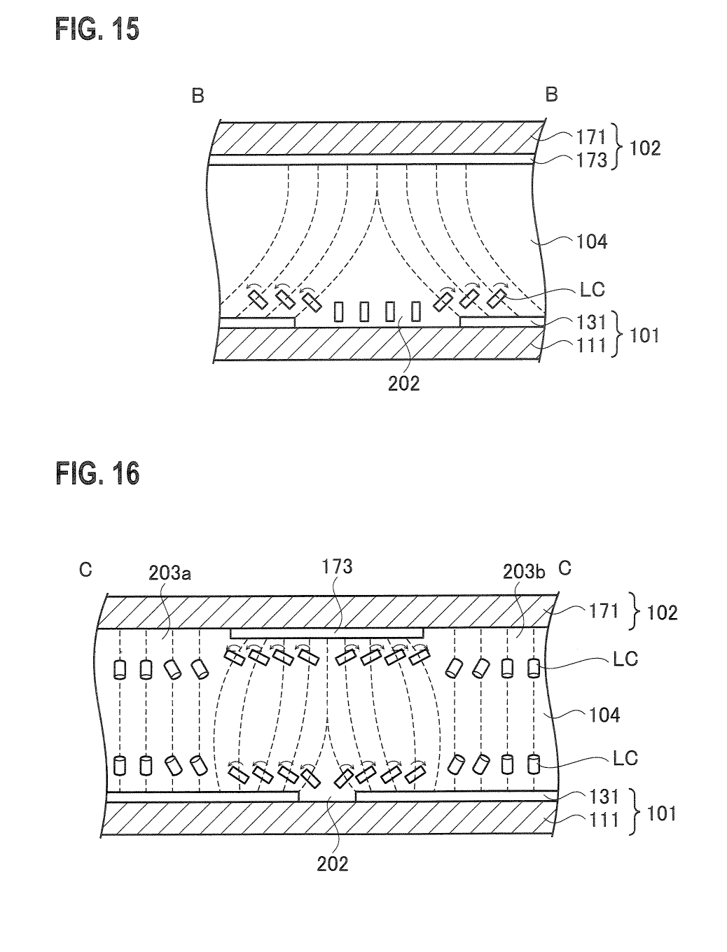

FIGS. 14 to 16 show cross-sectional views of one pixel in a case where a voltage is applied to the pixel electrode 131 and the opposite electrode 173. FIG. 14 is a cross-sectional view taken along the line A-A of FIG. 13, FIG. 15 is a cross-sectional view taken along the line B-B of FIG. 13, and FIG. 16 is a cross-sectional view taken along the line C-C of FIG. 13. In FIGS. 14 to 16, liquid crystal molecules LC present in each of surfaces of the pixel electrode 131 and of the opposite electrode 173 are also shown by rectangles. A potential difference is caused in accordance with a value of image signals applied between the pixel electrode 131 and the opposite electrode 173. The liquid crystal molecules are aligned by the electric field generated in a liquid crystal layer 104. In FIGS. 14 to 16, an electric flux line indicating a distribution of the generated electric field is shown by the dotted line.

As shown in the cross-sectional views of FIGS. 14 and 16, the electric field generated in a vicinity of the opposite electrode 173 is distributed in a manner that the electric field is kept off the slits 203a and 203b of the opposite electrode 173. Thereby, at the side of the opposite substrate 102, the liquid crystal molecules LC aligned vertically to the surfaces of the opposite electrode 173 and of the slits 203a and 203b incline toward the inside of the slits 203a and 203b.

On the other hand, as shown in the cross-sectional views of FIGS. 15 and 16, the electric field generated in a vicinity of the pixel electrode 131 is distributed in a manner that the electric field is kept off the slit 202. Thereby, at the side of an array substrate 101, the liquid crystal molecules aligned vertically to the surfaces of the pixel electrode 131 and of the slit 202 incline toward the outside of the slit 202. Accordingly, variations of inclination directions of the liquid crystal molecules in each pixel are suppressed. Thus, noise in display in the liquid crystal display device 1 can be suppressed.

As described above, according to the second embodiment, the slits 203a and 203b of the opposite electrode 173, which are provided in a shape including a discontinuous portion therein, control the inclination directions of the liquid crystal molecules to be in a direction toward the inside of the slits 203a and 203b. The slit 202 provided so as to face the discontinuous portion of the slits 203a and 203b controls the inclination directions of the liquid crystal molecules present in the discontinuous portion of the slits 203a and 203b to be in a direction to the inside of the slits 203a and 203b. Since a dielectric projection is absent on the opposite electrode 173 in the second embodiment, an amount of light passing through the liquid crystal layer 104 increases more than that in the first embodiment. Light leakage due to the vertically-aligned liquid crystal molecules is also further reduced. Accordingly, noise in display due to variations of the inclination directions of the liquid crystal molecules is suppressed, and a quality of display is thus improved.

### COMPARATIVE EXAMPLE

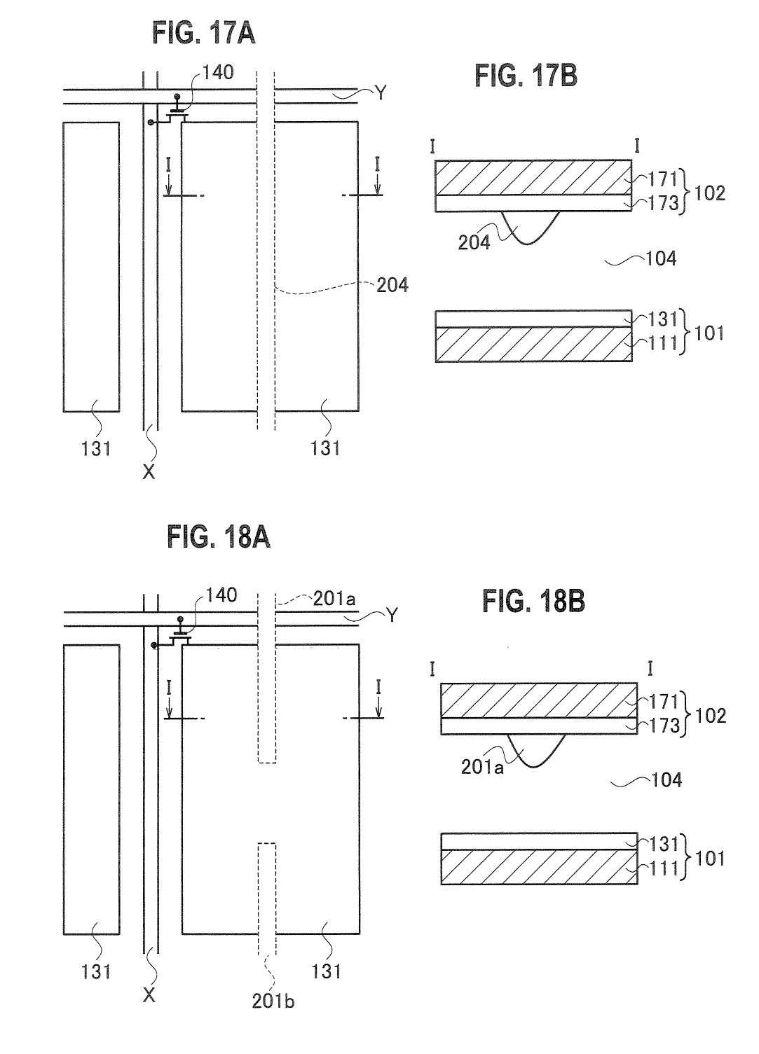

Next, a comparative example of a liquid crystal display device will be given in order to describe effects of each embodiment more clearly. A plan view of FIG. 17A shows one pixel disposed in a liquid crystal display device of a first comparative example. A projection 204 is provided to an opposite electrode 173 of an opposite substrate 102, and extends in a direction parallel to a signal line X without being divided. Here, a dielectric material is also used for the projection 204. In addition, as shown in a cross-sectional view of FIG. 17B, the projection 204 projects to the side of an array substrate 101. In this event, the height of the projection 204 is set at 1 μm, and the width thereof is set at 6 um.

A plan view of FIG. 18A shows one pixel disposed in a liquid crystal display device of a second comparative example. On an opposite substrate 102, projections 201a and 201b are provided to an opposite electrode 173 in a shape including a discontinuous portion therein. The projections are divided around the center of a pixel electrode 131. In addition, each of the projections 201a and 201b extends in a direction parallel to a signal line X. The projections 201a and 201b are provided to each pixel. In addition, as shown in a cross-sectional view of FIG. 18B, the projections 201a and 201b project to the side of the array substrate 101. The height of the projection 201 is set at 1 μm, and the width thereof is set at 6 um. It is to be noted that a slit 202 is not provided to the pixel electrode 131 in the first and second comparative example.

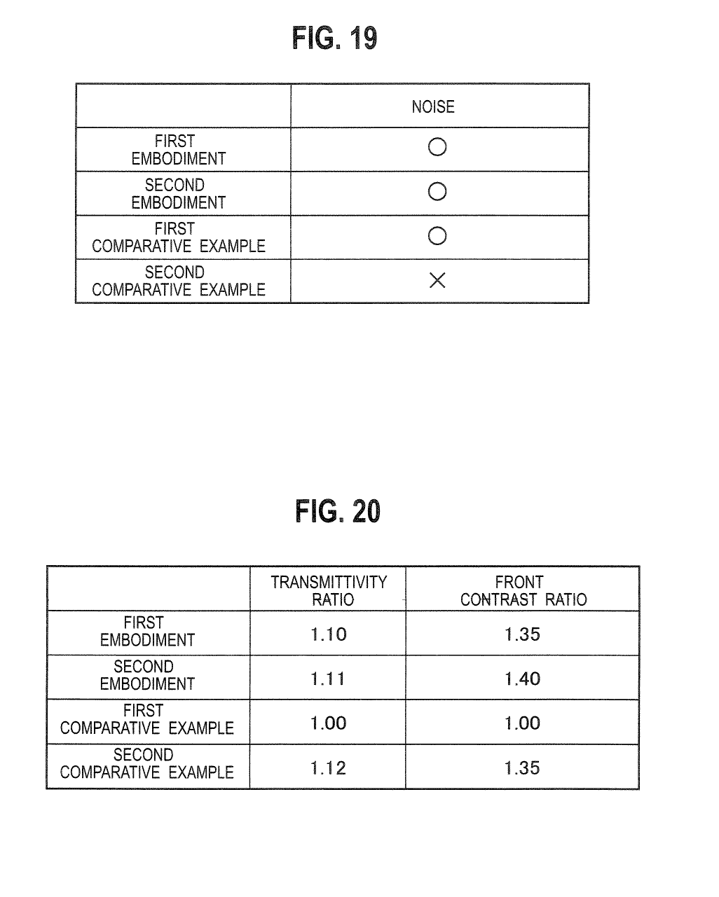

FIG. 19 shows results of comparisons as to whether or not noise is present when an image is displayed on a liquid crystal display device of each of the first and second comparative examples, and the first and second embodiments. The noise is absent in a display in the first comparative example, but is present in the second comparative example. This means that the inclination directions of the liquid crystal molecules are made uniform by the projections in the first comparative example, but that the inclination directions of the liquid crystal molecules present in the discontinuous portion are not sufficiently made uniform since the projections are divided in the second comparative example.

Noise is not present in display in the first and second embodiments. The projection is divided in the first embodiment, and the slit of the opposite electrode is divided in the second embodiment. However, a slit is provided to the pixel electrode so as to face the discontinuous portion thereof. Thereby, the inclination directions of the liquid crystal molecules present in the discontinuous portion are made uniform.

FIG. 20 shows results of comparisons between a transmittivity ratio and a front contrast ratio at the time when an image is displayed on the liquid crystal display device of each of the first and second comparative examples, and the first and second embodiments. Here, values of the transmittivity ratio and of the front contrast ratio of the first comparative example are standardized at 1.00. When compared with the transmittivity ratios in the first comparative example, the transmittivity ratios of the first embodiment, the second embodiment and the second comparative example are improved. In the first embodiment and the second comparative example, the dielectric projection is divided. Thereby, a proportion of the projection to the pixel electrode is smaller than that of the first comparative example. Thus, the transmittivity is improved by the proportion of the dielectric projection being smaller. Moreover, the dielectric projection is absent in the second embodiment. Thus, the transmittivity is further made higher than that of the first embodiment.

On the other hand, the front contrast depends on whether or not the liquid crystal molecules are vertical to the substrate in a state where a voltage is not applied. In the case of the first comparative example where the projection is present on the substrate, the liquid crystal molecules are aligned in an inclination direction in a vicinity of the projection. As a result, light is not completely shielded, and the front contrast is deteriorated. Since the projections are divided in the first embodiment and the second comparative example, the front contrast is improved as compared with that of the first comparative example. In addition, the front contrast in the second embodiment is the highest of the embodiments and the comparative examples because the projection is absent in the second embodiment.

Incidentally, the projections are provided as the first structure in the first embodiment, and the slit is provided to the pixel electrode as the second structure. In the second embodiment, the slit is provided as the first structure in the opposite electrode, and the slit of the pixel electrode is provided as the second structure. However, the configurations of the first and second structures are not limited to the above. For example, a projection may be provided to an opposite electrode as a first structure in a shape including a discontinuous portion therein, and a projection may be provided to a pixel electrode so as to face the discontinuous portion of the projection as a second structure. In addition, a slit may be provided to an opposite electrode as a first structure in a form including a discontinuous portion therein, and a projection may be provided to a pixel electrode as facing a discontinuous portion of the slit of the opposite electrode as a second structure. Also in such configurations, effects substantially similar to those of the first and second embodiments can be obtained.

### Third Embodiment

A basic configuration of a liquid crystal display device of a third embodiment is similar to that described in the first embodiment. Descriptions will be subsequently provided below mainly for points different from those of the first embodiment.

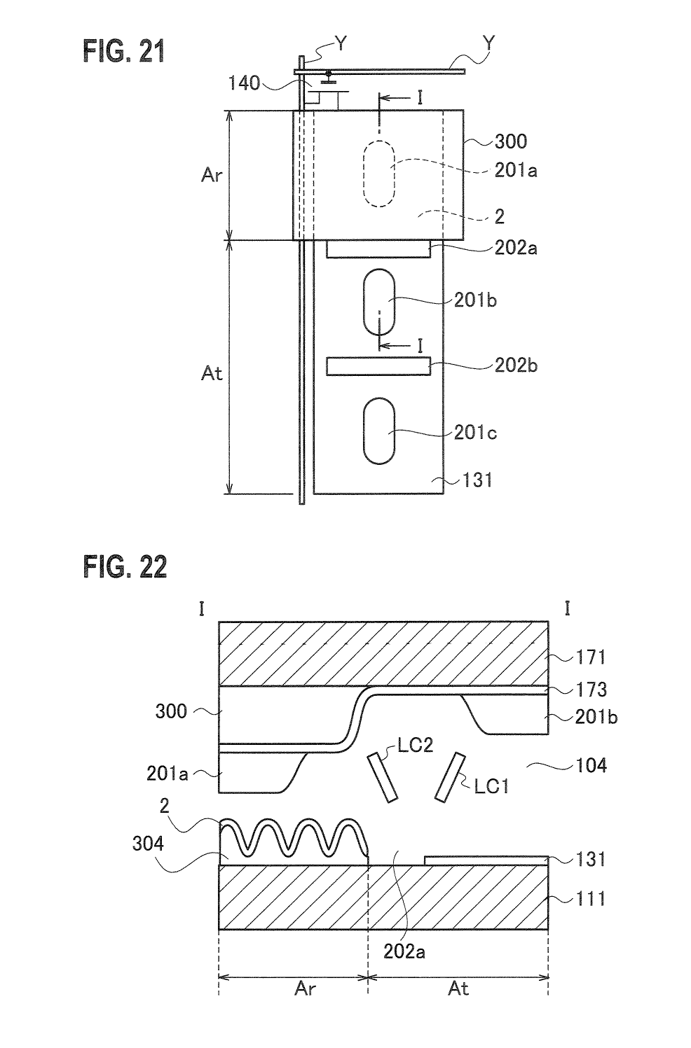

A liquid crystal display device of a third embodiment is a transflective liquid crystal display device having a multigap structure. As shown in a plan view of FIG. 21, this liquid crystal display device is provided to an opposite substrate as a first substrate and is further provided with a stepped portion 300 which adjusts a thickness of a liquid crystal layer. A pixel electrode as a second electrode is formed of a reflective electrode 2 and a transmissive electrode 131. The reflective electrode is disposed in a reflective region Ar where the stepped portion 300 makes the liquid crystal layer thinner than a second region. The transmissive electrode 131 is disposed in a transmissive region At where the liquid crystal layer is thicker. A slit 202a as a second structure straddles a boundary between the reflective region Ar and the transmissive region At.

Here, a slit 202a faces a discontinuous portion of projections 201a and 201b which are provided to the opposite electrode 173 of the opposite substrate in a form including a discontinuous portion therein. A transmissive electrode 131 is partially removed from slit 202a. Similarly, a slit 202b faces a discontinuous portion of projections 201b and 201c which are provided to the opposite electrode 173 in a shape including a discontinuous portion therein. The transmissive electrode 131 is partially removed from the slit 202b. The height of the projections 201a to 201c is set at 1 μm, and the width thereof is set at 6 μm. Also in this event, a dielectric material is used for the projections 201a to 201c. A value of permittivity is set to be a value at which an electric field generated in the liquid crystal is kept off these projections. The length of the slits 201a and 201b is set at 10 μm, and the width thereof is set at 4 μm. In addition, aluminum (hereinafter referred to as Al) is used for the reflective electrode 2. As in the case of the first embodiment, ITO, which is a light-transmissive conductive member, is used for the transmissive electrode 131.

FIG. 22 shows a cross-sectional view taken along the line I-I of FIG. 21. The array substrate and the opposite substrate face each other with a cell gap of 3.8 μm. A multigap structure is formed by providing the stepped portion 300 with a film thickness of 2 μm to the opposite electrode. The reflective electrode 2 is formed on an organic insulative film 304 with an uneven surface in a way that incident light is easily scattered. An unillustrated alignment layer with a thickness of 70 nm is provided to each of surfaces at the side of the array substrate and of the opposite substrate, which adjoin the liquid crystal layer 104. Here, a liquid crystal molecule LC1 is present in the transmissive region At in the liquid crystal layer 104, and a liquid crystal molecule LC2 is present in a vicinity of a boundary between the reflective region Ar and the transmissive region At. In a state where a voltage is not applied, the alignment layer causes each of the liquid crystal molecules LC1 and LC2 to incline by a pretilt angle, and to be aligned substantially vertically.

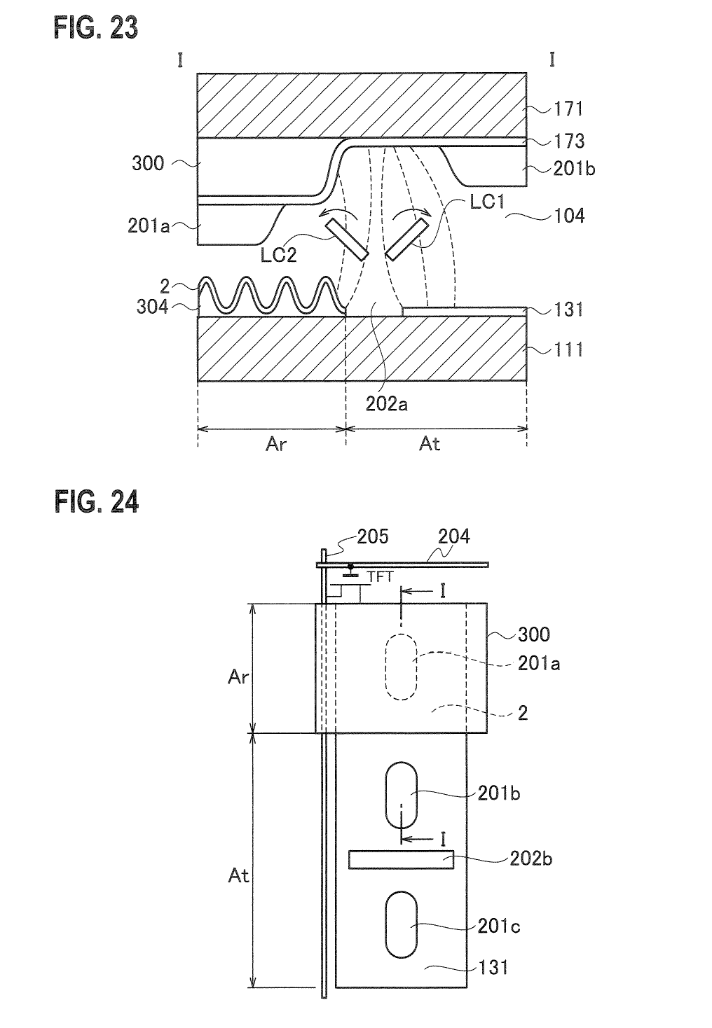

FIG. 23 shows a cross-sectional view taken along the line I-I of FIG. 21 at the time of displaying an image. A potential difference is generated in accordance with a value of image signals applied between the transmissive electrode 131 and the opposite electrode 173, and between the reflective electrode 2 and the opposite electrode 173. The liquid crystal molecules LC1 and LC2 are aligned by an electric filed generated in the liquid crystal layer 104. In FIG. 23, an electric flux line indicating a distribution of the generated electric field is shown by the dotted line.

The electric field generated from the surface of the opposite electrode 173 is distributed in a way that the electric field is kept off the slit 202a. Accordingly, the liquid crystal molecule LC1 in the transmissive region At inclines toward the right side. On the other hand, the liquid crystal molecule LC2 in a vicinity of the boundary between the reflective region Ar and the transmissive region At inclines toward the left side. The liquid crystal molecules LC1 and LC2 which incline by the pretilt angle, and which are aligned substantially vertically, incline in a direction equal to that of the pretilt angle. In this manner, the pretilt direction that the liquid crystal molecules have and a tilt direction at the time of applying a voltage are made equal to each other. As a result, a favorable display without an afterimage can be obtained because a movement of the liquid crystal is faster.

As described above, according to the third embodiment, the slit 202a as the second structure straddles the boundary between the reflective region Ar and the transmissive region At. Hence, in the liquid crystal layer 104 in which an electric field is generated at the time of applying a voltage, the inclination directions of the liquid crystal molecules present in a vicinity of a boundary between the reflective region Ar and the transmissive region At can be controlled. Accordingly, in addition to the effects of the first embodiment, an effect that the pretilt direction which the liquid crystal molecules have and the tilt direction at the time of applying a voltage is made equal, can be obtained. As a result, a favorable display without an afterimage can be obtained because a movement of the liquid crystal is faster.

### COMPARATIVE EXAMPLE

Here, a third comparative example of a liquid crystal display device will be given by using FIGS. 24 to 26 in order to describe the effects of the third embodiment more clearly.

As shown in a plan view of FIG. 24, a basic configuration of a liquid crystal display device of a third comparative example is similar to that described in the third embodiment. However, it is different in that a slit 202a is absent in a boundary between a reflective region Ar and a transmissive region At.

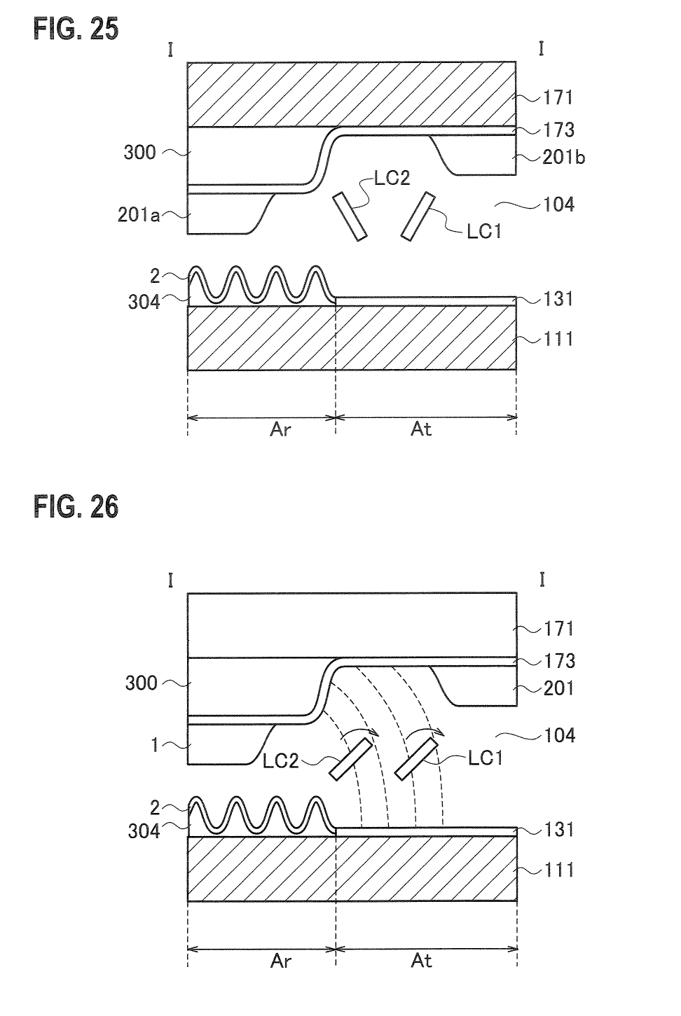

FIG. 25 shows a cross-sectional view taken along the line I-I of FIG. 24. Also in this event, in a state where a voltage is not applied, an alignment layer causes a liquid crystal molecule LC1 present in the transmissive region At and a liquid crystal molecule LC2 present in a vicinity of the boundary between the reflective region Ar and the transmissive region At to incline by a pretilt angle, and to be aligned substantially vertically.

FIG. 26 shows a cross-sectional view taken along the line I-I of FIG. 24 at the time of displaying an image. A potential difference is caused in accordance with a value of an image signal applied between the transmissive electrode 131 and the opposite electrode 173, and between the reflective electrode 2 and the opposite electrode 173. The liquid crystal molecules LC1 and LC2 are aligned by the electric field generated in the liquid crystal layer 104. In FIG. 26, an electric flux line indicating a distribution of the generated electric field is shown by the dotted line.

Since the liquid crystal molecule LC1 inclines in a direction equal to that of the pretilt angle (to the right in FIG. 26) by the electric filed generated from the surface of the opposite electrode 173, a movement thereof is fast. On the other hand, since the liquid crystal molecule LC2 present in a vicinity of a boundary between the reflective region Ar and the transmissive region At inclines in an opposite direction to that of the pretilt angle (to the right in FIG. 26), a movement thereof is slow.

In the liquid crystal display device of the third comparative example, an observed disadvantage was that a checker pattern is left as an afterimage for a several seconds in a case where a black display, gray display, black and white checker pattern display, and white display are sequentially switched to be displayed.

Against this background, in the third embodiment as described above, the slit 202a as the second structure is provided in a way that the slit 202a straddles the boundary between the reflective region Ar and the transmissive region At. Thereby, in the liquid crystal layer 104 in which the electric field is generated at the time of applying a voltage, the inclination directions of the liquid crystal molecules present in the vicinity of the boundary between the reflective region Ar and the transmissive region At can be controlled. Accordingly, the pretilt direction that the liquid crystal molecules have and the tilt direction at the time of applying the voltage are made equal to each other. As a result, a favorable display without an afterimage can be obtained because the movement of the liquid crystal is fast.

Incidentally, the liquid crystal display device of the third embodiment is provided with the slit 202a as the second structure, from which the transmissive electrode 131 is partially removed, in the boundary between the reflective region Ar and the transmissive region At. However, the second structure is not limited to a slit, and a dielectric projection may be provided. Also in such a case, effects similar to those of the present embodiment can be obtained.

In the liquid crystal display device of the third embodiment, a multigap structure is formed by providing the stepped portion, which adjusts a thickness of the liquid crystal layer, to the opposite substrate. However, the structure is not limited to this, and the multigap structure may be formed by providing the stepped portion to the array substrate or to both of the array substrate and the opposite substrate. Also in such a case, effects similar to those of the present embodiment can be obtained.

### Fourth Embodiment

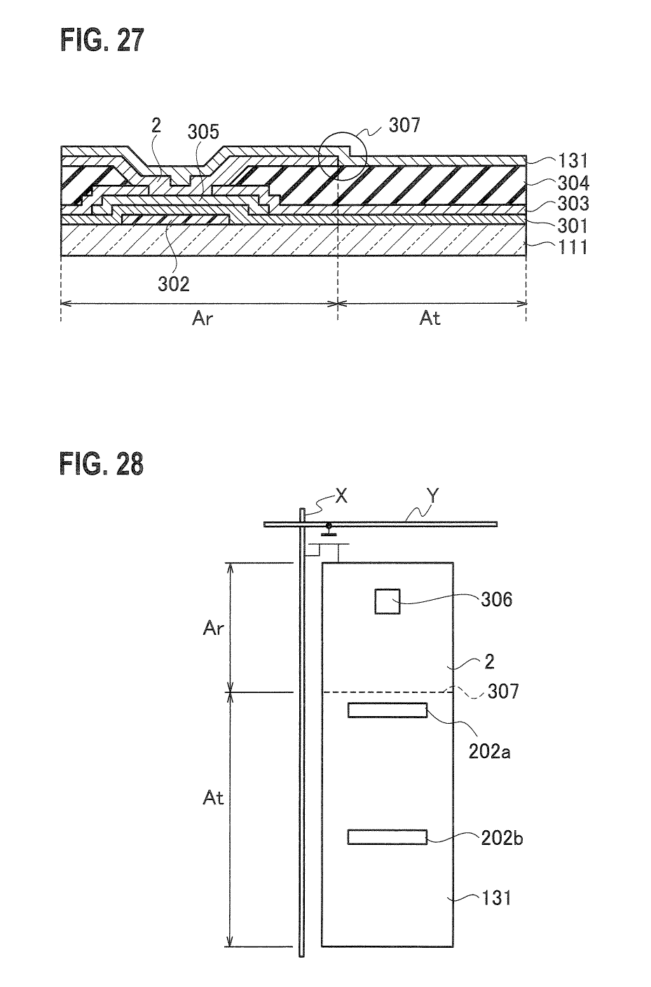

A basic configuration of a liquid crystal display device of a fourth embodiment is similar to that described in the third embodiment. Descriptions will be provided below for a liquid crystal display device of a fourth comparative example by using FIGS. 27 and 28.

FIG. 27 shows a cross-sectional view of an array substrate. A polysilicon film 302 is formed on an insulative substrate 111. An oxide film 301 is formed on the insulative substrate 111 and the polysilicon film 302. An auxiliary capacity line 305 is formed on the polysilicon film 302 through the oxide film 301. A passivation film 303 and an organic insulative film 304 are sequentially superposed on the oxide film 301 and the auxiliary capacity line 305. A contact hole passes through the passivation film 303 and the organic insulative film 304. A reflective electrode 2 is connected to the auxiliary capacity line 305 through the contact hole. Al is used for the reflective electrode 2. ITO is formed on the reflective electrode 2 as a transmissive electrode 131. In a boundary between a reflective region Ar and the transmissive region At, the transmissive electrode 131 extends over the reflective electrode 2 to form a stepped portion 307.

FIG. 28 shows a plan view of one pixel disposed in a liquid crystal display device of a fourth embodiment. A contact portion 306 is provided to the center of the reflective electrode 2 in order to be connected to the auxiliary capacity line 305. The silt 202a as the second structure extends along the boundary between the reflective region Ar and the transmissive region At. Here, the slit 202a of the transmissive electrode 131 is spaced apart by 1 μm from an end of the reflective electrode 2 to be the boundary. Thereby, the slit 202a of the transmissive electrode 131 is apart from the stepped portion 307. Accordingly, the transmissive electrode 131 can be prevented from being disconnected by the stepped portion 307. Thus, a yielding percentage due to a point defect is improved.

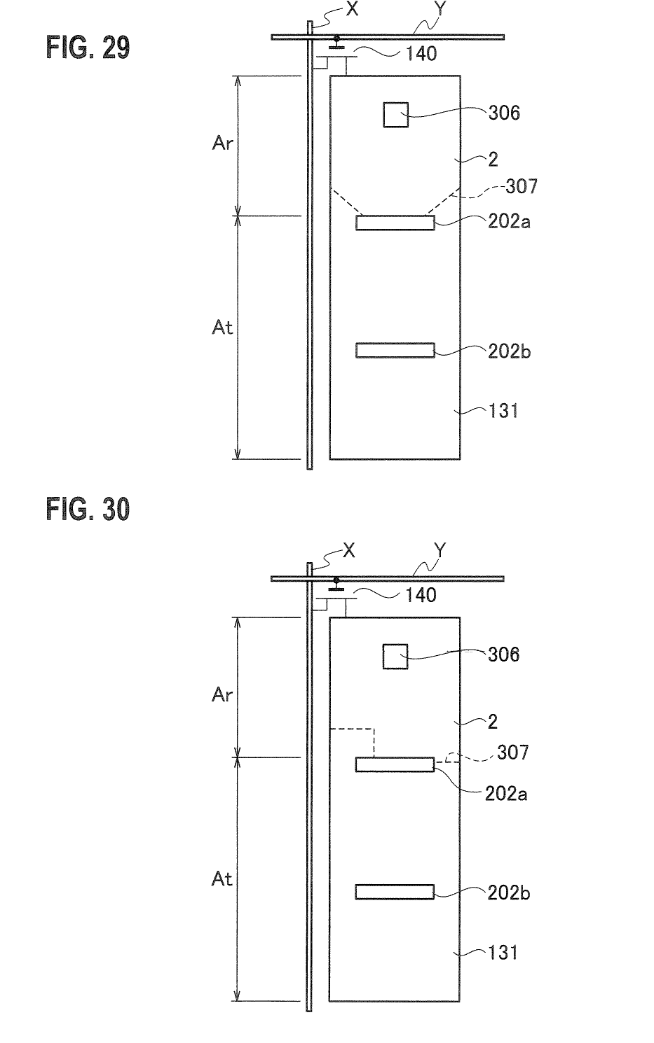

Next, a modified example of the liquid crystal display device of the fourth embodiment will be described. In a liquid crystal display device of a first modified example, as shown in a plan view of FIG. 29, the reflective electrode 2 is cut out while avoiding both ends of the slit 202a. With this, a portion where the transmissive electrode 131 is tapered at the both ends of the slit 202a can be apart from the stepped portion 307. Thus, it is possible to prevent the transmissive electrode 131 from being disconnected by the stepped portion 307.

In a liquid crystal display device of a second modified example, as shown in a plan view of FIG. 30, the reflective electrode 2 in a vicinity of the slit 202a is cut out so as to be unsymmetrical, and a left end of the reflective electrode 2 is cut out. A distance between the left end of the slit 202a and the reflective electrode 2 is different from a distance between the right side of the slit 202a and the reflective electrode 2. Thus, the portion where the transmissive electrode 131 is tapered at the left end of the slit 202a can be apart from the stepped portion 307. As a result, while an area of the reflective electrode 2 is maintained, the transmissive electrode 131 is prevented from being disconnected by the stepped portion 307. As another modified example, an end portion of a reflective electrode is formed to be a forward tapered shape. Accordingly, an angle of a stepped portion 307 is made smooth. Hence, a transmissive electrode 131 is prevented from being disconnected.

What is claimed is:

1. A liquid crystal display device comprising:
first and second substrates which are disposed so as to face each other with a gap interposed in between;
a first electrode disposed on the first substrate;
a second electrode disposed on the second substrate in a way that the second electrode faces the first electrode;
a liquid crystal layer which is held in the gap between the substrates, and which is formed of liquid crystal molecules having a negative dielectric anisotropy;
a first structure which is provided to the first electrode in a shape including a discontinuous portion therein, and which is configured to control inclination directions of the liquid crystal molecules; and
a second structure provided to the second electrode so as to face the discontinuous portion of the discontinuously-provided first structure.

2. The liquid crystal display device according to claim 1, wherein
the first structure is a projection provided to the first electrode in a shape including a discontinuous portion therein, and
the second structure is a slit which is formed by partially removing the second electrode, and which faces a discontinuous portion of the projection.

3. The liquid crystal display device according to claim 1, wherein
the first structure is a slit formed by partially removing the first electrode in a shape including a discontinuous portion therein, and
the second structure is a slit which is formed by partially removing the second electrode, and which faces a discontinuous portion of the slit of the first structure.

4. The liquid crystal display device according to claim 1, wherein
the first structure is a projection provided to the first electrode in a shape including a discontinuous portion therein, and
the second structure is a projection provided to the second electrode so as to face the discontinuous portion of the projection.

5. The liquid crystal display device according to claim 2, wherein
all the portions in the projection on the first electrode extend in one direction, and
the slit of the second electrode extends in a direction perpendicular to the direction in which all the portions of the projection extend.

6. The liquid crystal display device according to claim 3, wherein
all the portions in the slit of the first electrode extend in one direction, and
the slit of the second electrode extends in a direction perpendicular to the direction in which all the portions of the slit of the first electrode extend.

7. The liquid crystal display device according to claim 1, further comprising a stepped portion which is provided to at least one of the first and second substrates, and which is configured to adjust a thickness of the liquid crystal layer, wherein
the second electrode is formed of a reflective electrode and a transmissive electrode, the reflective electrode disposed in a first region where the stepped portion makes the liquid crystal layer thinner than a second region, and the transmissive electrode disposed in the second region where the liquid crystal layer is thicker, and
the second structure straddles a boundary between the two regions.

8. The liquid crystal display device according to claim 1, further comprising a stepped portion which is provided to at least one of the first and second substrates, and which is configured to adjust a thickness of the liquid crystal layer, wherein
the second electrode is formed of a reflective electrode and a transmissive electrode, the reflective electrode disposed in a first region where the stepped portion makes the liquid crystal layer thinner than a second region, and the transmissive electrode disposed in the second region where the liquid crystal layer is thicker, and
the second structure is along a boundary between the two regions.
